(19) United States
(12) Patent Application Publication
(10) Pub. No.: US 2026/0252007 A1
(43) Pub. Date: Aug. 27, 2026

(54) IMAGE FORMING APPARATUS

(71) Applicant: CANON KABUSHIKI KAISHA, Tokyo (JP)

(72) Inventors: KENGO KOYAMA, Chiba (JP); SUGURU TAKEUCHI, Chiba (JP); HIROSHI MIYAMOTO, Saitama (JP); YASUHARU TORATANI, Chiba (JP); AKIYOSHI SHINAGAWA, Saitama (JP); KIYONORI SOTOME, Ibaraki (JP); AYANO SAITO, Chiba (JP); MASAKI SUDA, Chiba (JP)

(21) Appl. No.: 19/451,108

(22) Filed: Jan. 16, 2026

(30) Foreign Application Priority Data
Feb. 21, 2025 (JP) 2025-027419

(51) Int. Cl. G03G 15/20; G03G 21/20

(52) U.S. Cl. CPC G03G 15/2039; G03G 15/2064; G03G 21/206; G03G 2221/1645

(57) ABSTRACT

An image forming apparatus includes a casing, a heating member disposed along a longitudinal direction perpendicular to a conveyance direction, a heater, and a sensor for detecting temperature of the heating member. To the sensor, no another sensor is disposed linear symmetrically with respect to a center of the heating member. A fan for generate an air flow inside the casing from a first end side of the heating member toward a second end side. The heater includes a first heater of which a heat generation amount at a center is larger than that at the first end side, and a second heater of which a heat generation amount at the first end side is larger than that at the center. A ratio of the heat generation amount of the second heater is changed in a case between first and second air flow rates of the fan.

### BACKGROUND

### Field of the Technology

The present invention relates to an image forming apparatus, such as a copier, a printer, a fax machine, or a multifunction printer with which a plurality of functions among these functions are provided, which apply an electrophotographic type or an electrostatic recording type with which a fixing portion which fixes a toner image on a recording material is provided.

### Description of the Related Art

In the image forming apparatus such as a copier which applies the electrophotographic type, a toner image is formed on the recording material which is sheet shaped, and the toner image is fixed on the recording material when the recording material which carries the unfixed toner image is heated and pressed by a fixing portion. In general, the fixing portion includes a heating member which applies heat to the recording material and a heater which heats the heating member. The heating member is configured to form a heating rotatable member to nip and convey the recording material together with a pressing rotatable member and is configured to apply heat to the recording material via the heating rotatable member.

The fixing portion may be configured to include a heater in which a heat generation amount is higher at a central portion than at end sides and another heater in which a heat generation amount is higher at the end sides than at a central portion in a direction which is substantially perpendicular to a conveyance direction of the recording material (hereinafter also referred to as a longitudinal direction). The reason is for purposes as the following. In the fixing portion, depending on a size of the recording material (width in the longitudinal direction), an area in which a temperature is easily decreased since heat is taken by the recording material as the recording material passes through, and an area in which the temperature is easily increased since the recording material does not pass through, are generated. Therefore, the area in which the recording material does not pass through may be overheated, and the heating portion, the heater, etc. may be damaged. Further, when the toner image is fixed on the recording material which is large in size while an area in which the recording material which is small in size is overheated, a hot offset of the toner may be occurred in the overheated area. Therefore, by appropriately settings a ratio of a heat generation of the two types of heaters which are described above, it is possible to suppress overheating of the heating member at a position in which the recording material does not pass through in the end sides in the longitudinal direction .

Further, the fixing portion is also provided with a temperature detecting member (temperature sensor) such as a thermistor for detecting the temperature of the heating member in order to control the temperature of the heating member. In this case, the plurality of temperature detecting member may be disposed asymmetrically in a longitudinal direction (Japanese Laid-Open Patent Application (JP-A) 2022-180914). This is to be able to detect overheating of the heating member at the position in which the recording material does not pass through in the end sides for each of different sizes of the recording materials which pass through the fixing portion, while reducing the number of the temperature detecting member.

### SUMMARY

An image forming apparatus comprising: a casing: an image forming portion provided inside the casing and configured to form a toner image on a recording material; a fixing portion provided inside the casing and configured to fix the toner image, formed by the image forming portion, onto the recording material, the fixing portion being provided with a heating member disposed along a longitudinal direction substantially perpendicular to a conveyance direction of the recording material, a heater configured to heat the heating member, and a sensor configured to detect a temperature of the heating member; a fan configured to generate an air flow inside the casing from a first end side of the heating member toward a second end side opposite to the first end side in the longitudinal direction; a supplying portion configured to supply a electric power to the heater; and a controller configured to control the supplying portion, wherein to the sensor, no another sensor is disposed at a linearly symmetric position with respect to a center of the heating member in the longitudinal direction, wherein the heater includes a first heater of which a heat generation amount at a position corresponding to a central portion of the heating member in the longitudinal direction is larger than a heat generation amount at a position corresponding to the first end side or which heats at the position corresponding to the central portion and does not heat at the position corresponding to the first end side, and a second heater of which a heat generation amount at the position corresponding to the first end side is larger than a heat generation amount at the position corresponding to the central portion in the longitudinal direction or which heats at the position corresponding to the first end side and does not heat at the position corresponding to the central portion, and wherein the controller controls the supplying portion to change a ratio of the heat generation amount of the second heater between a case in which an air flow rate of the fan is a first air flow rate and a case in which the air flow rate of the fan is a second air flow rate different from the first air flow rate.

Further features of the present disclosure will become apparent from the following description of exemplary embodiments with reference to the attached drawings.

### BRIEF DESCRIPTION OF THE DRAWINGS

FIG. 1 is a sectional view showing a schematic configuration of a printer.

FIG. 2 is a block diagram showing a schematic control configuration of the printer.

FIG. 3 is a block diagram illustrating a schematic configuration for performing a temperature control of a fixing portion.

FIG. 4 is a sectional view showing a schematic configuration of the fixing portion.

FIG. 5 is a sectional view showing a schematic configuration of a fixing portion according to the other embodiment.

FIG. 6 is a sectional view showing a schematic configuration of a fixing portion according to the other embodiment.

FIG. 7 is a schematic diagram illustrating a disposition of a fixing temperature sensor.

FIG. 8 is an illustration showing a setting of an air flow rate of an exhaust heat fan.

FIG. 9 is a graph showing a distribution of a heat generation amount of a heater.

FIG. 10 is a graph illustrating temperature distributions of a heating roller according to a comparative example.

FIG. 11 is an illustration showing a setting of a heat generation amount of the heater.

FIG. 12 is a graph illustrating temperature distributions of the heating roller according to an embodiment.

FIG. 13 is a block diagram showing an schematic control configuration for controlling the heat generation amount of the heater.

FIG. 14 is a flow chart showing a schematic procedure of controlling the heat generation amount of the heater.

Part (a) and part (b) of FIG. 15 are schematic views showing another example in which the fixing temperature sensors are asymmetrically disposed in a longitudinal direction.

### DESCRIPTION OF THE EMBODIMENTS

In the following, an image forming apparatus according to the present invention will be furthermore specifically described with reference to figures.

### First embodiment

### Image forming apparatus

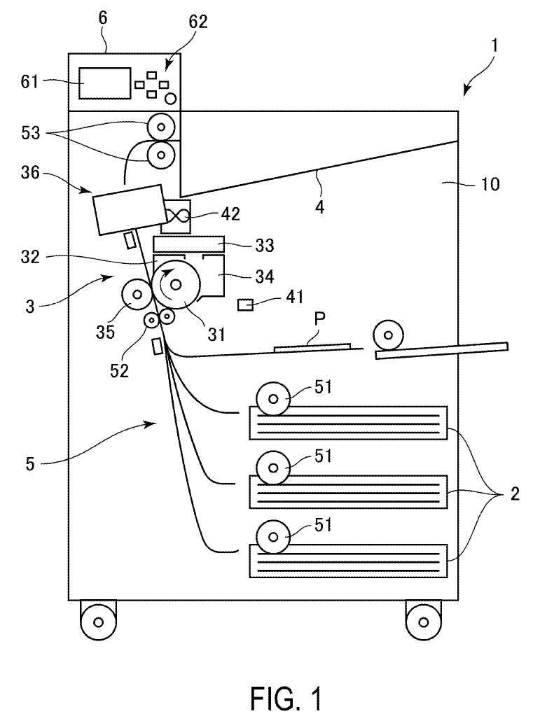

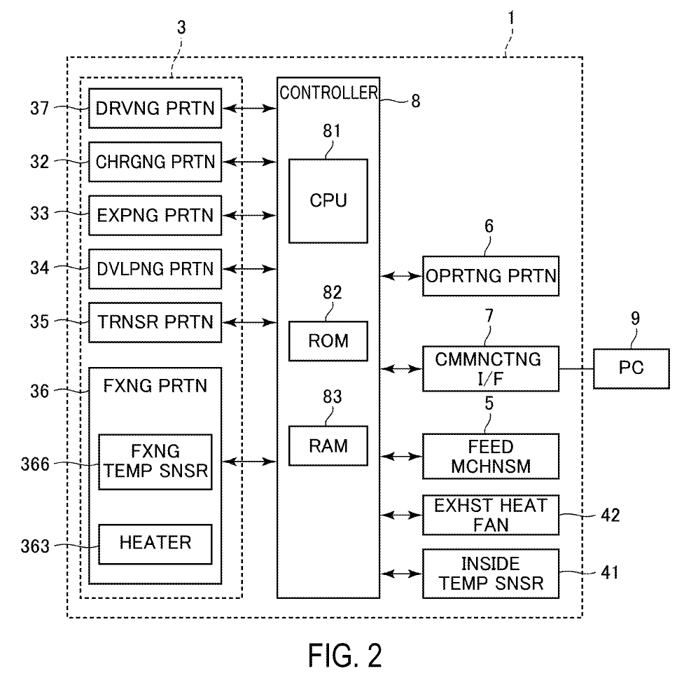

FIG. 1 is a sectional view showing a schematic configuration of the image forming apparatus according to an embodiment. In the embodiment, the image forming apparatus is a printer 1 which forms a monochrome (black monochrome) image on a recording material P which is sheet shaped by using an electrophotographic type. Further, FIG. 2 is a block diagram showing an overview of a control configuration of the printer 1 according to the embodiment.

Incidentally, for the printer 1 and its elements, a front side of the drawing sheet of FIG. 1 is defined as a front (front surface) side, and a rear side of the drawing sheet of FIG. 1 is defined as a rear (back surface) side. In the embodiment, a direction which is perpendicular to the drawing sheet of FIG. 1 which connects the front side and the rear side (front-back direction) is substantially parallel to a rotational axis direction of a photosensitive drum 31 and a rotational axis direction (longitudinal direction) of a heating roller 362 which will be described below. Further, the recording material is also referred to as a paper or a sheet, however, it is not limited to being made of paper, but it may include materials which are made of materials other than paper or include material other than paper such as a plastic sheet, a synthetic paper, etc.

As shown in FIG. 1, the printer 1 includes a plurality of sheet feeding cassettes 2 which accommodate the recording material P (transfer material, recording medium) such as paper whose sizes are different respectively, and an image forming portion 3 which forms an image on the recording material P which is conveyed from the sheet feeding cassette 2. Further, the printer 1 includes a discharging tray 4 to which the recording media P on which the image has been formed by the image forming portion 3 is discharged, a sheet conveyance mechanism 5 which conveys the recording media P, and an operation portion 6 which receives an operation instruction from a user.

Further, as shown in FIG. 2, the printer 1 includes a communication interface (communication I/F) 7 and a controller 8. The communication I/F 7 is for transmitting and receiving a print data, a printer control command, etc. which are operational instructions to order the printer 1 to perform image forming with a PC (Personal Computer) 9 which is connected via a cable, etc. in a way which is capable of transmitting and receiving the data. The controller 8 includes a CPU (Central Processing Unit) 81, etc. The CPU 81 outputs a control signal to control an operation of each portion such as the image forming portion 3 and the sheet conveyance mechanism 5 according to the print data and the printer control command which are received via the communication I/F 7, and orders the printer 1 to perform the image forming operation.

As seeing in FIG. 1, the sheet conveyance mechanism 5 includes a feeding roller 51, a conveying roller 52, and a discharging roller 53, etc. The feeding roller 51 feeds the recording material P one sheet by one sheet from the sheet feeding cassette 2 and conveys it toward the image forming portion 3. The conveying roller 52 conveys the recording material P which is fed from the feeding roller 51 to the image forming portion 3 in synchronization with time when the image forming operation is performed by the image forming portion 3. The discharging roller 53 discharges the recording material P, which is conveyed from the image forming portion 3, into the discharging tray 4.

The operation portion 6 includes a display device 61 which is configured of a liquid crystal display, etc. for displaying an operation guide to a user, etc. Further, the operation portion 6 includes a key switch 62 which receives an operation instruction when a user selects an operation guide display which is shown on the display device 61 or enters data such as a set value.

The image forming portion 3 forms an image on the recording material P by using an image data which is output from the CPU 81. In the embodiment, the image forming portion 3 includes the photosensitive drum 31, a charging portion 32, an exposure portion 33, a developing portion 34, a transfer portion 35, and a fixing portion 36. The photosensitive drum 31 is a drum shaped image bearing member whose surface is configured of a photosensitive member (electrophotographic photosensitive member). The photosensitive drum 31 rotates in a clockwise direction in FIG. 1. A charging device 32 charges the surface of the photosensitive drum 31 which is rotating. The exposure portion 33 exposes the photosensitive drum 31 by outputting a laser light based on the image data from the CPU 81 and forms an electrostatic latent image (electrostatic image) on the photosensitive drum 31. The developing portion 34 supplies toner as a developer to the electrostatic latent image which is formed on the photosensitive drum 31 and forms a toner image (toner image, developer image) on the photosensitive drum 31. The transfer portion 35 transfers the toner image on the photosensitive drum 31 to the recording material P. In the embodiment, the transfer portion 35 is configured of a roller (transfer roller) which contacts the photosensitive drum 31, and transfers the toner image onto the recording material P which is nipped and conveyed between the photosensitive drum 31 and the transfer portion 35. The fixing portion 36 fixes (melts and adheres) the toner image on the recording material P by heating and pressing the recording material P onto which the toner image has been transferred. Details of the fixing portion 36 will be described below.

Further, the printer 1 includes an inside temperature sensor 41 as an inside temperature detecting means (atmosphere temperature detecting means) which detects an atmosphere temperature inside the printer 1 in a vicinity of the image forming portion 3 inside the apparatus (inside a casing 10 of the printer 1).

Furthermore, the printer 1 includes an exhaust heat fan 42 which functions to discharge air from the inside of the apparatus to an outside of the apparatus (outside the casing 10 of the printer 1) as a blowing means for controlling the inside temperature of the apparatus. In the embodiment, the exhaust heat fan 42 is mainly provided to reduce the inside temperature of the apparatus. More specifically, in the embodiment, the exhaust heat fan 42 is mainly provided to release heat from the fixing portion 36 from the inside of the apparatus to the outside of the apparatus and to prevent the inside temperature of the apparatus from increasing excessively. Therefore, in the embodiment, the exhaust heat fan 42 is disposed near the fixing portion 36 inside the apparatus. Further, in the embodiment, the exhaust heat fan 42 is mounted adjacent to a discharging opening (not shown) which is provided on a side surface of a rear side of the casing 10 of the printer. The exhaust heat fan 42 may include a plurality of fans. The exhaust heat fan 42 generates an air flow in a substantially one direction at least in a vicinity of the fixing portion 36 from a perspective of exhaust heat efficiency, etc. Incidentally, the printer 1 may include an intake fan which mainly functions to suck air from the outside of the apparatus to the inside of the apparatus either instead of or in addition to the exhaust heat fan 42. The intake fan may include a plurality of fans. In a case that the intake fan is applied, it also generates the air flow in the substantially one direction at least in the vicinity of the fixing portion 36 in the same manner as described above.

The CPU 81 controls the inside temperature of the apparatus to keep an appropriate temperature by operating the exhaust heat fan 42 based on a detected result of the inside temperature of the apparatus which is obtained by the inside temperature sensor 41. Here, in general, an air flow rate of a fan is described in terms of a volume of an air which can be supplied per unit time (for example, m³/min), etc., however, it may be represented by a rotational speed of the fan (or rotational frequency). In the embodiment, the exhaust heat fan 42 operates to generate an air flow inside the apparatus in a direction from a front side toward a rear side of the printer 1. That is, in the embodiment, a suction opening (not shown) is provided in a front door which configures a part of a side surface of the front side of the casing 10 of the printer 1. The exhaust heat fan 42 sucks a fresh air from the outside of the apparatus to the inside of the apparatus through the suction opening and discharges the air which is heated in the inside of the apparatus from the inside of the apparatus to the outside of the apparatus through the discharging opening which is provided on the rear side of the casing 10. In the embodiment, the fixing portion 36 is disposed so that a side of one end side of the heating roller 362 in the longitudinal direction is positioned on the front side, and a side of the other end side is positioned on the rear side. Therefore, the air flows from the front side to the rear side so as to cross the fixing portion 36 along the longitudinal direction.

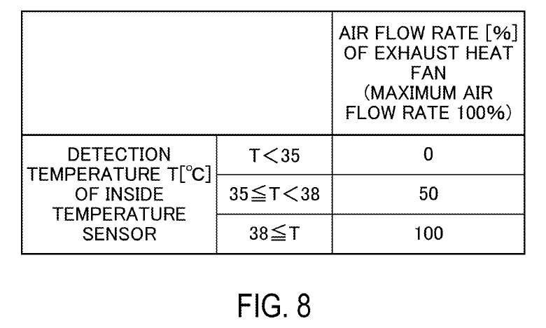

FIG. 8 is an illustration (table) showing a relationship between a detected result of the inside temperature of the apparatus by the inside temperature sensor 41 and an air flow rate of the exhaust heat fan 42 (air flow rate ratio in a case that a maximum air flow rate is 100%). Specifically, in the embodiment, as shown in FIG. 8, the CPU 81 controls the exhaust heat fan 42 so that the air flow rate of the exhaust heat fan 42 is increased as the inside temperature of the apparatus which is detected by the inside temperature sensor 41 is increased. Information which shows the relationship between the detected result of the inside temperature of the apparatus by the inside temperature sensor 41 and a setting of the air flow rate of the exhaust heat fan 42 as shown in FIG. 8 is stored in a ROM 82 which will be described below.

A control configuration of the printer 1 according to the embodiment will be further described with reference to FIG. 2. The controller 8 includes a CPU 81, a ROM (Read Only Memory) 82, a RAM (Random Access Memory) 82, etc. The CPU 81 controls an overall operation of the printer 1. The ROM 82 stores a control program for the printer 1, etc. The RAM83 stores data (calculation result and detected result) which are applied by the CPU 81, etc. The controller 8 is connected to, for example, a driving portion 37 which rotationally drives a driven member, a charging portion 32 (charging voltage application portion), an exposure portion 33, a developing portion 34 (developing voltage application portion), a transfer portion 35 (transfer voltage application portion), a heater 363 and a fixing temperature sensor 366 of the fixing portion 36 which will be described below, etc. The driving portion 37 transmits a driving force to, for example, the photosensitive drum 31 and a pressing roller 361 of the fixing portion 36 which will be described below. The driving portion 37 may include an independent driving source for each driven member, or a driving source may be shared among a plurality of driven members. Further, the controller 8 is connected to the inside temperature sensor 41, the exhaust heat fan 42, the operation portion 6, the communication I/F 7, the sheet conveyance mechanism 5, etc.

The CPU 81 performs a temperature control (temperature adjustment control) of the fixing portion 86 and a driving control of the exhaust heat fan 42 by reading the control program from the ROM 82 and executing the control program using the RAM 83. Further, the CPU 81 controls each portion of the printer 1 and performs the image forming operation by executing the control program as the same manner as described above. Further, the CPU 81 receives the printer control command and the print data from a PC 9 via the communication I/F 7, generates image data based on the print data, and outputs the image data to the exposure portion 33.

### Overview of temperature control of the fixing portion

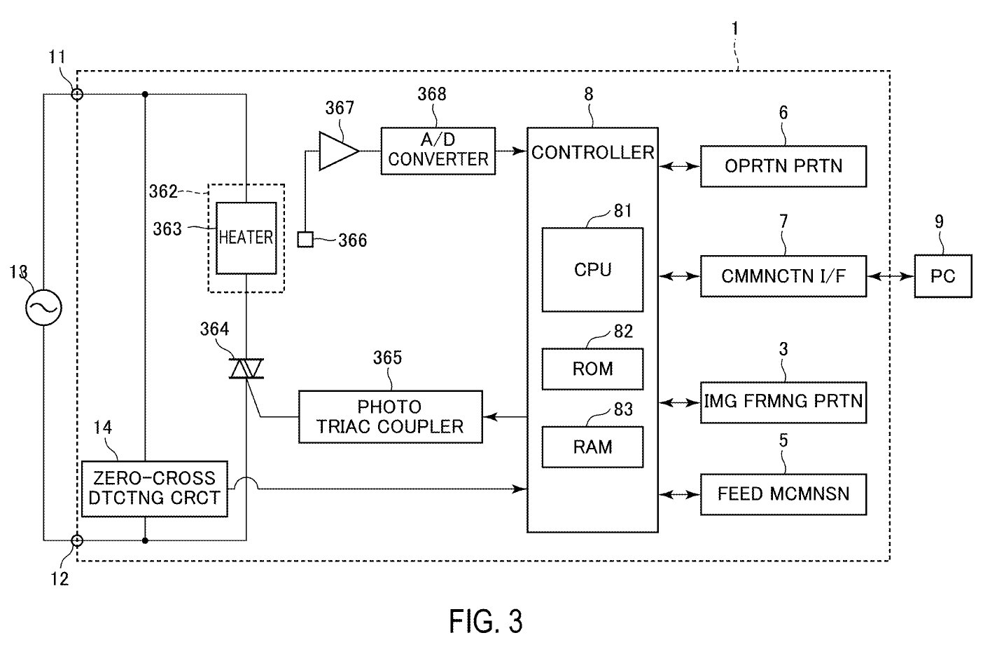

With reference to FIG. 3, an overview of a temperature control of the heating roller 362 of the fixing portion 36 by the CPU 81. FIG. 3 is a block diagram showing a schematic configuration for performing the temperature control of the fixing portion 36. Incidentally, as specifically described below, the fixing portion 36 includes the heating roller 362 which applies heat to the recording material P and the heater 363 which heats the heating roller 362.

The printer 1 includes a power source connection terminal 11 and a power source connection terminal 12. And an AC power source 13 is connected between the power source connection terminal 11 and the power source connection terminal 12. Further, the heater 363 and a triac 364 are connected in series between the power source connection terminal 11 and the power source connection terminal 12. Further, a gate of the triac 364 is connected to the CPU 81 via a photo-triac coupler 365. In this way, while the triac 364 and the CPU 81 are insulated, the triac 364 is turned on and off according to a control signal from the CPU 81 and an electric power supply to the heater 363 is turned on and off.

Further, a zero-cross detection circuit 14, which detects a zero-cross timing in which an AC voltage crosses 0V, is connected between the power source connection terminal 11 and the power source connection terminal 12. A zero-cross signal, which indicates the zero-cross timing detected by the zero-cross detection circuit 14, is output from the zero-cross detection circuit 14 to the CPU 81.

Further, the printer 1 includes the fixing temperature sensor 366 which is a temperature detecting member (temperature detecting element) as a fixing temperature detecting means, which detects a temperature of the heating roller 362 and outputs a voltage corresponding to the temperature. The fixing temperature sensor 366 for detecting the temperature of the heating roller 362 is configured to include, for example, a thermistor or a thermocouple. The fixing temperature sensor 366 is provided in a vicinity of the heating roller 362. And the output voltage from the fixing temperature sensor 366 is output to an A/D converter 368 via an amplifier 367, and, furthermore, is output to the CPU 81 after an analog/digital conversion is performed by the A/D converter 368. In this way, it is possible to obtain a current temperature T of the heating roller 362 by the CPU 81.

Further, the CPU 81 controls the fixing portion 36 (heater 363) so that the heating roller 362 reaches a predetermined temperature, based on the current temperature T which is output from the A/D converter 368, whenever the zero-cross signal is output from the zero-cross detection circuit 14. For example, the CPU 81 outputs a control signal to the photo-triac coupler 365 to turn off the triac 364 when the current temperature T is higher than a predetermined target temperature which is a target of the temperature control. Further, when the current temperature T is lower than the predetermined target temperature, the CPU 81 outputs the control signal to the photo-triac coupler 365 to turn the triac 364 on. Therefore, for example, in a case that the AC voltage which is output from the AC power source 13 is 50Hz, the temperature control is executed at 10ms (half-wavelength of 50Hz) intervals. In this way, by synchronizing an output timing of the control signal in which the CPU 81 turns on the triac 364 with the zero-cross signal, it is possible to turn on the triac 364 while reducing a voltage stress on the triac 364.

### Fixing portion

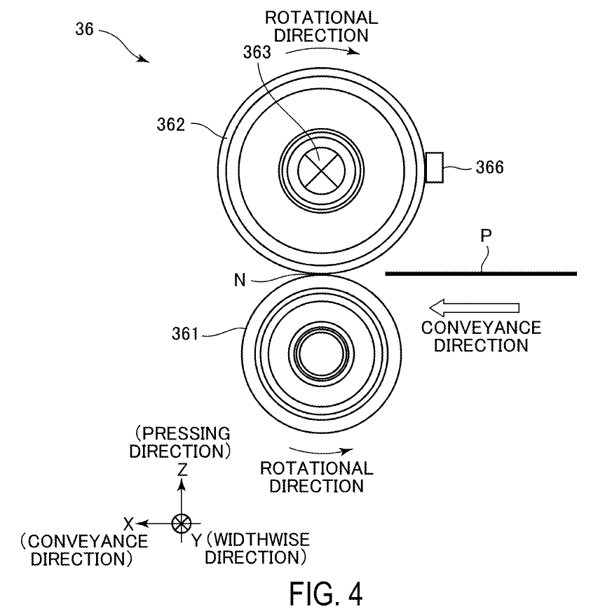

Next, with reference to FIG. 4, the fixing portion (fixing device) 36 according to the embodiment will be further described. FIG. 4 is a sectional view showing a schematic configuration of the fixing portion 36 in the embodiment (showing a sectional view substantially perpendicular to the rotational axis of the heating roller 362). In the embodiment, the fixing portion 36 is configured as a roller heating type fixing device. In FIG. 4, an X direction indicates a conveyance direction of the recording material P, a Y direction indicate a width direction which is substantially perpendicular to the conveyance direction of the recording material P, and a Z direction indicates a direction which is perpendicular to both the X direction and the Y direction. The Y direction (width direction of the recording material P) is substantially parallel to a rotational axis direction (longitudinal direction) of the heating roller 362. Further, the Z direction is substantially parallel to a direction in which the pressing roller 361 presses the recording material P against the heating roller 362 (pressing direction). Further, the fixing portion 36 is disposed so that the Y direction is substantially parallel to a front-back direction (direction perpendicular to the drawing sheet of FIG. 1) which connects the front side and the rear side of the printer 1.

As shown in FIG. 4, the fixing portion 36 includes the heating roller 362 and the pressing roller 361. In the embodiment, the heating roller 362 as a heating member for applying heat to the recording material P, configures a heating rotatable member which rotates in contact with the recording material P and melts the toner image which is formed on the recording material P. In the embodiment, the pressing roller 361 as a pressing rotatable member (pressing member) forms a fixing nip portion N between the pressing roller 361 and the heating roller 362 by pressing against the heating roller 362 and presses the recording material P, which passes through the fixing nip portion N, toward the heating roller 362. Incidentally, the pressing roller 361 may only press against the heating roller 362, relatively. The configuration may be pressing the pressing roller 361 toward the heating roller 362, pressing the heating roller 362 toward the pressing roller 361, or pressing the heating roller 362 and the pressing roller 361 toward each other.

The heating roller 362 is configured of an aluminum pipe whose thickness is 2mm. The heater 363 as a heat source (heat generating member) for heating the heating roller 362 is provided inside the heating roller 362 (hollow portion). The heater 363 is capable of generating heat up to a predetermined temperature.

The pressing roller 361 is configured of a roller which includes a core metal (shaft), an elastic layer which is provided on an outer periphery of the core metal, and a mold releasing layer which is provided on an outer periphery of the elastic layer. The core metal is configured of a cylindrical portion which is made of SUS (stainless steel) whose diameter is 44mm. The elastic layer is made of conductive silicone rubber with a thickness of 8mm. The mold releasing layer is made of PFA (tetrafluoroethylene perfluoroalkoxy vinyl ether copolymer) with a thickness of 100μm. The pressing roller 361 is rotatably supported by a frame (not shown) of the fixing portion 36. A gear is fixed to one end side of the pressing roller 361 with respect to a direction of a rotational axis of the pressing roller 361, and the pressing roller 361 is connected via the gear to a driving source (not shown) of the driving portion 37. The pressing roller 361 is rotationally driven by a driving force which is transmitted via the gear. Incidentally, in the embodiment, the heating roller 362 is rotated in accordance with a rotation of the pressing roller 361.

The fixing temperature sensor 366 is provided in contact with or in close proximity to a surface (outer peripheral surface) of the heating roller 362. And, as described above, the electric power which is supplied to the heater 363 is turned on and off in accordance with the control signal from the CPU 81 based on temperature information of the heating roller 362 which is detected by the fixing temperature sensor 366.

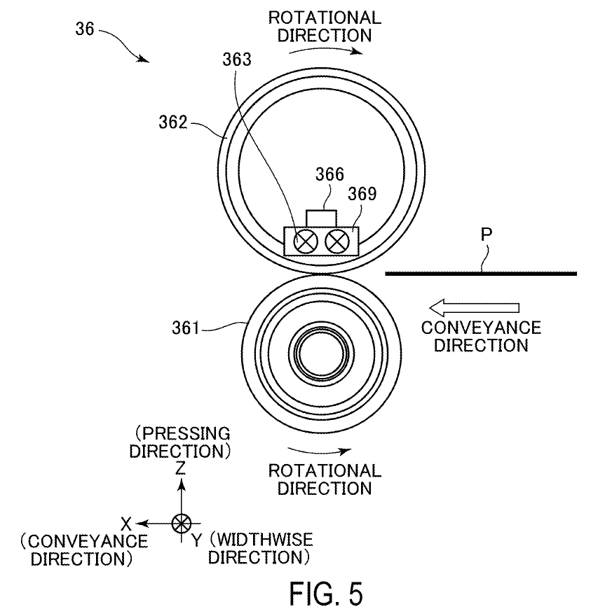

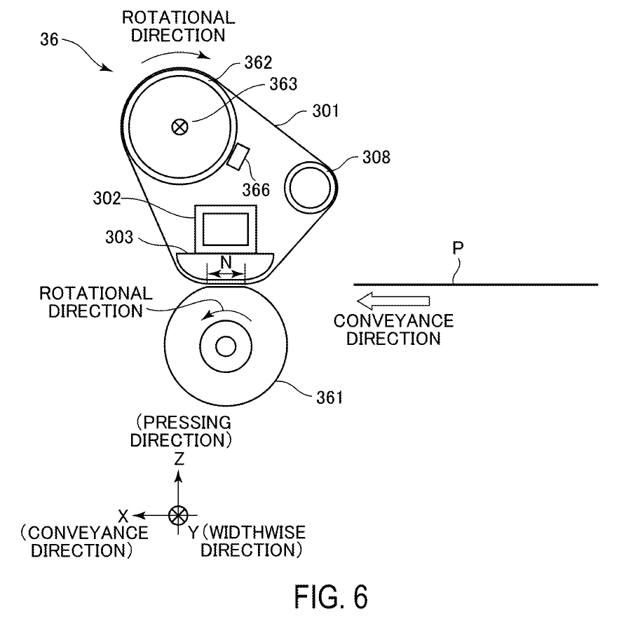

Incidentally, the fixing portion 36 is not limited to the configuration which is described above. Other embodiments of the fixing portion 36 will be described with reference to FIG. 5 and FIG. 6.

First of all, the other embodiment of the fixing portion 36 shown in FIG. 5 will be described. The fixing portion 36 which is shown in FIG. 5 includes a heating rotatable member 362, the pressing roller 361 as a pressing rotatable member (pressing member), the heater 363, and a heater holding member 369 which holds the heater 363. The heater 363 heats the heater holding member 369. In this fixing portion 36, the fixing nip portion N is formed in which the recording material P is nipped and conveyed, when the pressing roller 361 is pressed by the heater holding member 369 via the heating rotatable member 362. In the fixing portion 36, the heater holding member 369 as a heating member applies heat to the recording material P via the heating rotatable member 362. The heating rotatable member 362 is configured of, for example, a flexible cylindrical member (belt, tube). The pressing roller 361 is rotationally driven by the driving force from the driving source, and the heating rotatable member 362 is rotationally driven in accordance with the rotation of the pressing roller 361. In the fixing portion 36, the heater 363 is provided in a vicinity of the fixing nip portion N. In the case, the fixing temperature sensor 366 is disposed in a vicinity of the heater 363 (heater holding member 369) inside the heating rotatable member 362 (hollow portion).

Next, the other embodiment of the fixing portion 36 which is shown in FIG. 6 will be described. The fixing portion 36 which is shown in FIG. 6 includes a fixing belt 301 which is configured of an endless belt as a heating rotatable member. Further, the fixing portion 36 includes a pressing pad 303 for supporting the fixing belt 301, a stay 302 for supporting the pressing pad 303, and the heating roller 362 which contacts an inner peripheral surface of the fixing belt 301 and heats the fixing belt 301. Further, the fixing portion 36 is provided inside the heating roller 362 (hollow portion) and includes the heater 363 which heats the heating roller 362. In the fixing portion 36, the heating roller 362 as the heating member applies heat to the recording material P via the fixing belt 301. Further, the fixing portion 36 includes the fixing temperature sensor 366 which detects the temperature of the heating roller 362 which is disposed in contact with or close proximity to the surface (outer peripheral surface) of the heating roller 362 on the inner peripheral surface side of the fixing belt 301. Further, the fixing portion 36 includes a steering roller 308 which contacts the inner peripheral surface of the fixing belt 301 and controls a shift (meandering) of the fixing belt 301. Further, the fixing portion 36 includes the pressing roller 361 as the pressing rotatable member (pressing member), which is pressed by the pressing pad 303 via the fixing belt 301 and forms the fixing nip portion N with the fixing belt 301.

The fixing belt 301 is configured of a thin walled cylindrical member which exhibits heat conducting properties and heat resisting properties. The fixing belt 301 is configured as a three layer structure which includes, for example, a base layer, an elastic layer which is provided on an outer periphery of the base layer, and a mold releasing layer which is provided on an outer periphery of the elastic layer. A thickness of the base layer is 80μm, for example, and polyimide resin (PI) is applied as a material of the base layer. A thickness of the elastic layer is 300μm, for example, and silicone rubber is applied as a material of the elastic layer. Further, a thickness of the mold releasing layer is 30μm and PFA (tetrafluoroethylene perfluoroalkoxy vinyl ether copolymer) is applied as a material of the mold releasing layer. The fixing belt 301 is stretched by the pressing pad 303, the heating roller 362, and the steering roller 308. The pressing pad 303 is pressed by the pressing roller 361 while nipping the fixing belt 301. As a material for the pressing pad 303, for example, LCP (liquid crystal polymer) is applied. A sliding member (not shown) may be interposed between the pressing pad 303 and the fixing belt 301. Further, a lubricant may be applied on the inner peripheral surface of the fixing belt 301. In this way, the fixing belt 301 slides smoothly against the sliding member. As for the lubricant, for example, silicone oil may be applied. The fixing belt 301 is heated by the heating roller 362. Incidentally, the number of the heater 363 may be one or more than one. As for the heating roller 362 and the pressing roller 361, the configuration which is similar to the embodiment which is described above may be applied.

In the fixing portion 36 which is shown in FIG. 6, while the recording material P which carries a toner image is nipped and conveyed in the fixing nip portion N which is formed between the fixing belt 301 and the pressing roller 361, the toner image is heated and the toner image is fixed to the recording material P. Therefore, it is necessary to achieve both a function of applying heat and pressure and a function of conveying the recording material P. The pressing roller 361 is rotationally driven by the driving force from the driving source, and the fixing belt 301 is rotationally driven in accordance with the rotation of the pressing roller 361. The pressing roller 361 is pressed against the pressing pad 303 via the fixing belt 301. A pressing force which is applied in the fixing nip portion N during printing is, for example, 1600N, and a width of the fixing nip portion N in the X direction (conveyance direction of the recording material P) may be set to 20mm, for example, and a width of the fixing nip portion N in the Y direction (width direction of the sheet) may be set to 350mm.

The steering roller 308 rotates (incline), so that a rotational axis of the steering roller 308 is inclined with respect to the rotational axis of the heating roller 362, centered on a rotational axis which is positioned at one end side or in a vicinity of the center in the direction of the rotational axis of the steering roller 308. In this way, a tension difference between a front side and a rear side of the fixing belt 301 is generated, and a position of the fixing belt 301 in the Y direction (width direction of the recording material P) is controlled. The steering roller 308 may be configured of, for example, a hollow roller which is made of SUS with a diameter of 20mm. A surface layer which is configured of rubber material, etc. may be provided on a surface of the steering roller 308, in order to increase a grip force against the fixing belt 301.

### Fixing temperature sensor

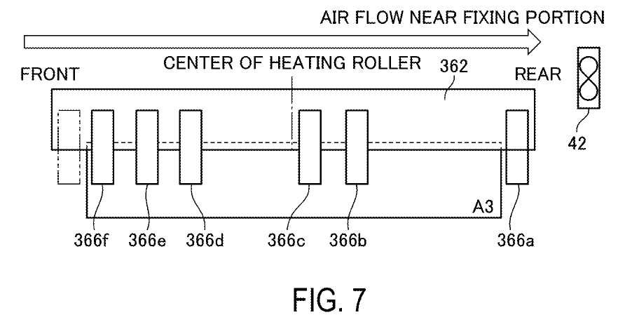

Next, with reference to FIG. 7, an arrangement of the fixing temperature sensor 366 according to the embodiment will be described. FIG. 7 is a schematic view illustrating the arrangement of the fixing temperature sensor 366 according to the embodiment.

In the embodiment, six pieces of the fixing temperature sensors 366 are disposed at different positions with respect to the longitudinal direction. The six pieces of the fixing temperature sensors 366 are defined as a first fixing temperature sensor 366a, a second fixing temperature sensor 366b, a third fixing temperature sensor 366c, a fourth fixing temperature sensor 366d, a fifth fixing temperature sensor 366e, and a sixth fixing temperature sensor 366f from a rear side to a front side. The six pieces of the fixing temperature sensors from 366a through 366f are asymmetrically disposed with respect to a center of the heating roller 362 in the longitudinal direction. In the embodiment, the six pieces of the fixing temperature sensors from 366a through 366f are asymmetrically disposed with respect to the center of the heating roller 362 in the longitudinal direction and disposed on both sides with respect to the center of the heating roller 362 in the longitudinal direction. Here, the center of the heating roller 362 in the longitudinal direction is defined as a “0” position. Further, the rear side is defined as a “+” position and the front side is defined as a “-” position. with respect to the “0” position. And this time, the first fixing temperature sensor 366a is disposed at a position of +165mm, the second fixing temperature sensor 366b is disposed at a position of +50mm, the third fixing temperature sensor 366c is disposed at a position of +10mm, the fourth fixing temperature sensor 366d is disposed at a position of -75mm, the fifth fixing temperature sensor 366e is disposed at a position of -115mm, and the sixth fixing temperature sensor 366f is disposed at a position of -145mm. Incidentally, a position of the fixing temperature sensor 366 is, for example, represented at a center of a temperature measuring area. Incidentally, the position of each of the fixing temperature sensors 366 is not limited to the position which is described above in the embodiment. The position of each of the fixing temperature sensors 366 is set so that it is possible to detect a temperature rising level of the heating roller 362 at a position in which the recording material P does not pass through in an end side with respect to the longitudinal direction, when the recording material P whose size is different (width in the longitudinal direction) passes through the fixing nip portion N. For example, as shown in FIG. 7, when the recording material P, whose width is the same size as an A3 sheet, passes through the fixing nip portion N, the position of the first fixing temperature sensor 366a is positioned on an outside of an endmost portion of the recording material P on the rear side. Therefore, in this case, it is possible to determine whether or not an excessive temperature rise is occurred based on the temperature which is detected by the first fixing temperature sensor 366a. Further, for example, when the recording material P, whose width is the same size as an A4R sheet, passes through the fixing nip portion N, the position of the fifth fixing temperature sensor 366e is positioned on an outside of an endmost portion of the recording material P on the front side. Therefore, in this case, it is possible to determine whether or not the excessive temperature rise is occurred based on the temperature which is detected by the fifth fixing temperature sensor 366e.

### Heater

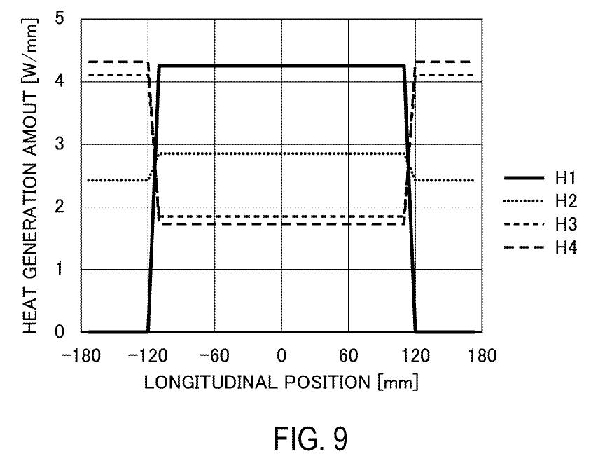

Next, with reference to FIG. 9, a distribution of the heat generation amount of the heater 363 according the embodiment will be described. FIG. 9 is a graph showing a relationship between a position of the heater 363 with respect to the longitudinal direction and the heat generation amount [W/mm] of the heater 363.

In the embodiment, the heater 363 is configured of a halogen heater. However, it is not limited to this, but any heating member may be applied as a heating member which configures the heater 363. The heater 363 may, for example, be configured of a ceramic heater. In the embodiment, the fixing portion 36 includes four heaters as the heater 363. First of all, the fixing portion 36 includes two central heaters (first heaters) H1 and H2, which mainly generate heat in a central portion with respect to the longitudinal direction as the heater 363. Further, the fixing portion 36 includes two end side heaters (second heaters) H3 and H4, which mainly generate heat in both end sides with respect to the longitudinal direction as the heater 363. That is, the central heaters H1 and H2 are heaters whose heat generation amount is higher in the central portion than in the end sides with respect to the longitudinal direction. Further, the end side heaters H3 and H4 are heaters whose heat generation amount is higher in the end sides than in the center with respect to the longitudinal direction. FIG. 9 is the graph showing the distribution of the heat generation amount in the longitudinal direction when the heaters from H1 through H4 generate heat at their maximum output. In the embodiment, the heat generation amount (at the maximum output) of each of the heater from H1 through H4 is approximately from 1000W to 1200W.

Incidentally, in the embodiment, the fixing portion 36 includes four heaters in total, which are two central heaters H1 and H2, and two end side heaters H3 and H4, however, it is not limited to this. The number of the central heaters and the end side heaters may be reduced or increased from the numbers which are specified in the embodiment, respectively. Further, a ratio of the numbers of the central heaters to end side heaters may be changed from the ratio which is specified in the embodiment.

### Temperature distribution

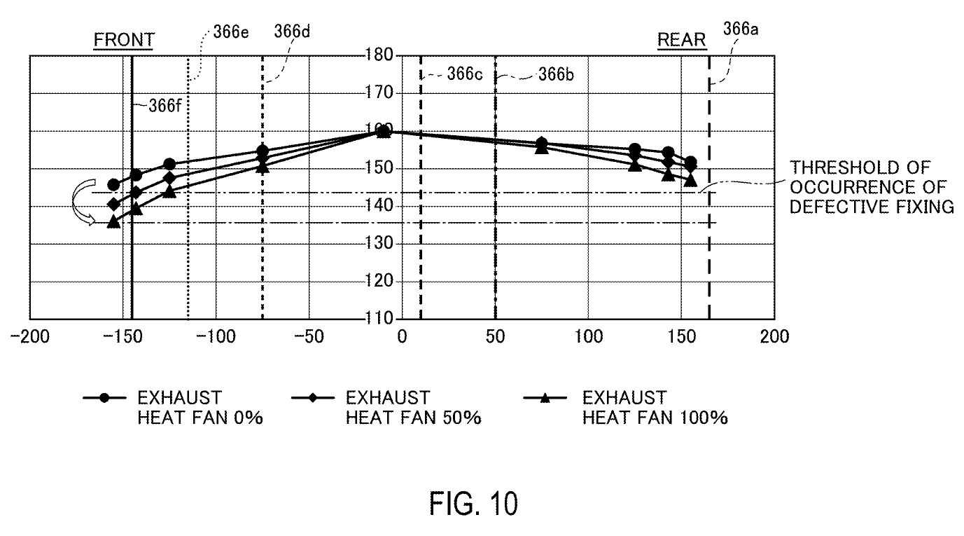

Next, with reference to FIG. 10, the temperature distributions of the heating roller 362 with respect to the longitudinal direction will be described. FIG. 10 is the graph showing the temperature distributions of the heating roller 362 in the longitudinal direction in a case that a heat generation amount control in the embodiment which will be described below is not performed (comparative example). FIG. 10 is the graph showing the temperature distributions in a case that the air flow rate of the exhaust heat fan 42 (air flow rate ratio in the case that the maximum air flow rate is 100%) is set to 0%, 50%, and 100%, respectively. Further, FIG. 10 is the graph showing the temperature distributions in a case that the heat generation amount (output ratio in a case that the maximum output is 100%) of each of the heaters from H1 through H4 is set to 50%. Further, FIG. 10 is the graph showing the temperature distributions while the fixing portion 36 is sufficiently heated and the temperature control of the heating roller 362 is performed based on a detected result of temperature by the third fixing temperature sensor 366c. Therefore, FIG. 10 may correspond to the temperature distributions while the recording material P is passing through the fixing nip portion N during a job execution (hereinafter, also referred to as “during sheet passing”). A job is a sequence of operations which is executed upon a single start command and forms and outputs an image on a single or a plurality of recording materials P. Incidentally, a configuration of the printer 1 in the comparative example, in which the results shown in FIG. 10 are obtained, is substantially the same as that of the printer 1 according to the embodiment, except that it does not perform the heat generation amount control in the embodiment which will be described below.

As shown in FIG. 10, the temperature distributions of the heating roller 362 in the longitudinal direction is substantially symmetrical with respect to the longitudinal direction (● plot) in the case that the air flow rate of the exhaust heat fan 42 is 0%. On the other hand, the temperature distributions of the heating roller 362 in the longitudinal direction are not symmetrical and the temperatures on the front side are particularly decreased (◆, ▲ plots) in the case that the air flow rate of the exhaust heat fan 42 is 50% or 100%. Further, as the air flow rate of the exhaust heat fan 42 increases, the decrease amount of the temperature on the front side becomes greater (◆, ▲ plots). This is because when the exhaust heat fan 42 operates, the fresh air flows from the front side to the rear side of the printer 1 and cooler air is passed through the front side of the fixing portion 36.

Here, temperature at a position of a plot in an endmost portion in the graph of FIG. 10 corresponds to temperature at an endmost portion of an image area. In a case of the comparative example which is shown in FIG. 10, the temperature at that position may become lower than a fixing defect occurrence threshold value. In the arrangement of the fixing temperature sensor 366 in the embodiment which is shown in FIG. 7, for example, it is not possible to detect the temperature in the end side which is on the outside of the sixth fixing temperature sensor 366f in the longitudinal direction on the front side during sheet passing of the recording material P whose width is the same as A3 sheet. Therefore, it is not possible to detect when the temperature at that position becomes lower than the fixing defect occurrence threshold value. On the other hand, it is possible to detect the temperature at the position which is outside of the endmost portion of the image area on the rear side by the first fixing temperature sensor 366a. However, even when the temperature at the position is detected, it is difficult to detect (or estimate) the decrease in temperature on the front side with sufficient accuracy.

In this way, it may be able to detect the decrease in temperature on the front side, when the temperature distribution of the heating roller 362 in the longitudinal direction is detected by using the plurality of fixing temperature sensors which are provided at a plurality of points in the longitudinal direction. However, in the configuration in which the fixing temperature sensors 366 are disposed asymmetrically in the longitudinal direction, it is difficult to detect (or estimate) the temperature distribution of the heating roller 362 in the longitudinal direction with sufficient accuracy and it is not possible to detect that the temperature on the front side is excessively decreased.

### Control of heat generation amount of heater

Next, heat generation amount control of the heater 363 will be described in the embodiment. In the embodiment, in response to the above issue, a ratio of a heat generation amount of the end side heaters H3 and H4 to a total heat generation of the central heaters H1 and H2 and the end side heaters H3 and H4 (ratio of heat generation) is changed according to the air flow rate of the exhaust heat fan 42. In other words, a ratio of the heat generation amount of the end side heaters H3 and H4 to a heat generation amount of the central heaters H1 and H2 (ratio of heat generation) is changed.

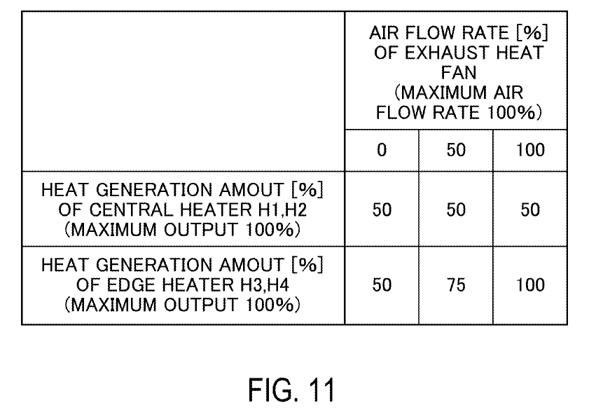

FIG. 11 is an illustration (table) showing a relationship between the air flow rate of the exhaust heat fan 42 during the job execution (during sheet passing) in the embodiment (air flow rate ratio in a case that a maximum air flow rate is 100%) and each of the heat generation amounts of the central heaters H1 and H2 and the end side heaters H3 and H4 (output ratio in the case that the maximum output is 100%).

Specifically, in the embodiment, as shown in FIG. 11, the CPU 81 changes the heat generation amount of the end side heaters H3 and H4 (output ratio in the case that the maximum output is 100%) among the heaters 363 (the central heaters H1 and H2, and the end side heaters H3 and H4) in accordance with the airflow rate of the exhaust heat fan 42. In the embodiment, as the air flow rate of the exhaust heat fan 42 increases, the heat generation amount of the end side heaters H3 and H4 (output ratio in the case that the maximum output is 100%) among the heaters 363 (the central heaters H1 and H2, and the end side heaters H3 and H4) is increased. In this way, the ratios of the heat generation of the end side heaters H3 and H4 with respect to the total heat generation amount of the heaters 363 (the central heaters H1 and H2, and the end side heaters H3 and H4) are increased. In other words, the ratios of the heat generation of the end side heaters H3 and H4 with respect to the heat generation amount of the central heaters H1 and H2 are increased.

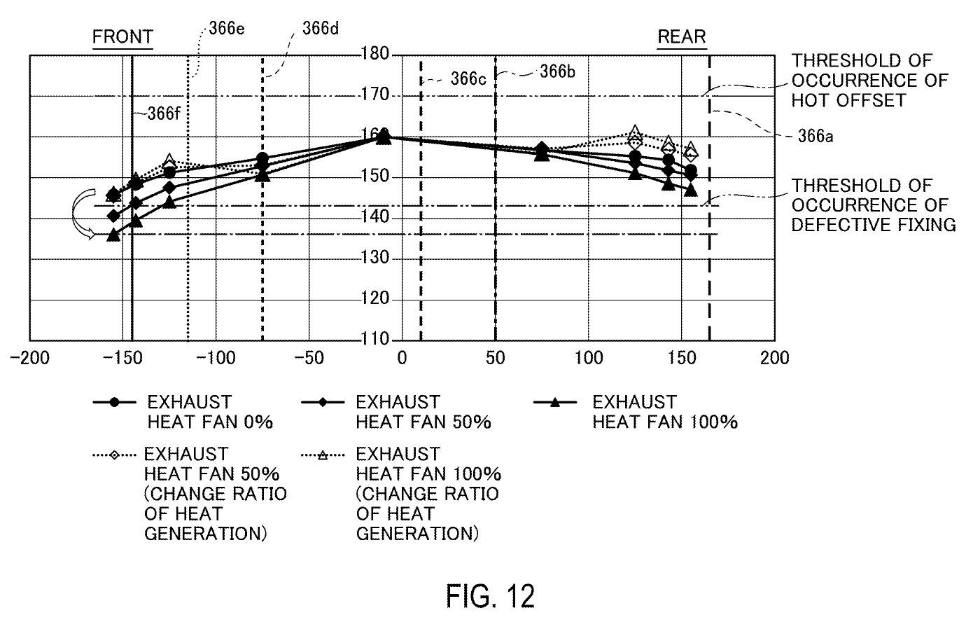

FIG. 12 is a graph similar to FIG. 10, showing the temperature distributions of the heating roller 362 in the longitudinal direction in a case that the heat generation amount control is performed according to the embodiment. FIG. 12 also shows plots of the comparative example which is shown in FIG. 10 for comparison. In FIG. 12, ◇ and △ plots show the temperature distributions in a case that the air flow rates of the exhaust heat fan 42 (air flow rate ratio in a case that a maximum air flow rate is 100%) are set to 50% and 100%, respectively, and the heat generation amount control is performed according to the embodiment. In a case that the air flow rate of the exhaust heat fan 42 is 0%, ● plot is used for both the comparative example and the embodiment.

As shown in FIG. 12, it is possible to prevent the temperature distributions of the heating roller 362 in the longitudinal direction, particularly the temperature on the front side from becoming below the fixing defect occurrence threshold value (◇, △ plots) by performing the heat generation amount control. Information, which indicates the relationship between the air flow rate of the exhaust heat fan 42 and each of the heat generation amounts of the central heaters H1 and H2 and the end side heaters H3 and H4 (output ratio in the case that the maximum output is 100%) as shown in FIG. 11, is determined in advance based on the relationship which is obtained experimentally and shown in FIG. 12, and stored in the ROM 82.

Here, in the embodiment, the heat generation amount of the central heaters H1 and H2 (output ratio in the case that the maximum output is 100%) among the heaters 363 (the central heaters H1 and H2, and the end side heaters H3 and H4) is not changed according to the air flow rate of the exhaust heat fan 42. The reason for this is that the air flow rate of the exhaust heat fan 42 does not substantially affect the temperature which is detected by the third fixing temperature sensor 366c, which is used for the temperature control of the heating roller 362. The third fixing temperature sensor 366c is the fixing temperature sensor 366 which detects temperature at an approximate center of the heating roller 362 in the longitudinal direction.

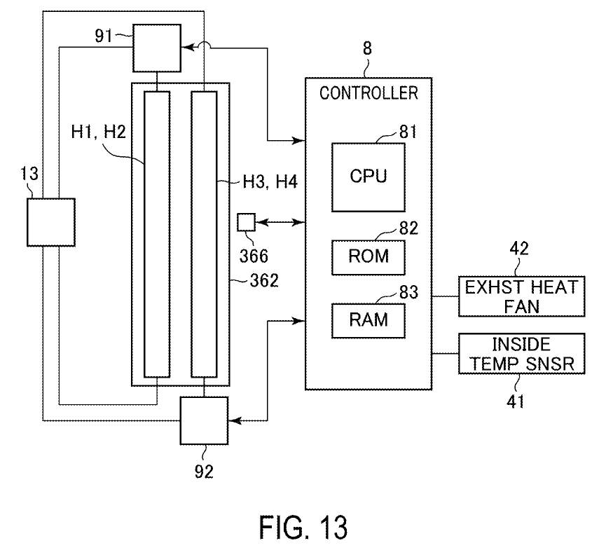

FIG. 13 is a block diagram showing a schematic of a control configuration focusing on the heat generation amount control according to the embodiment. As described above, the ROM 82 stores information which indicates a relationship between the inside temperature and the air flow rate of the exhaust heat fan 42 as shown in FIG. 8. The CPU 81 controls the air flow rate of the exhaust heat fan 42 based on the detected result of the inside temperature by the inside temperature sensor 41. Further, as described above, the ROM 82 stores the information which indicates the relationship between the air flow rate of the exhaust heat fan 42 and each of the heat generation amounts of the central heaters H1 and H2 and the end side heaters H3 and H4 (output ratio in the case that the maximum output is 100%) as shown in FIG. 11. The CPU 81 turns on or off the electric power supply to the central heaters H1 and H2 and the end side heaters H3 and H4 based on the detected result of the temperature of the heating roller 362 by the fixing temperature sensor 366, and the CPU 81 controls to change the ratio of the heat generation of the end side heaters H3 and H4 with respect to the total heat generation amount of the heaters 363 (the central heaters H1 and H2, and the end side heaters H3 and H4) in accordance with the air flow rate of the exhaust heat fan 42. In the embodiment, it is possible to adjust the electric power which is supplied to the central heaters H1 and H2 from the power source 13, when the electric power supply to the central heaters H1 and H2 from the power source 13 is turned on, by a first adjustment portion 91. Further, in the embodiment, it is possible to adjust the electric power which is supplied to the end side heaters H3 and H4 from the power source 13, when the power supply to the central heaters H1 and H2 from the power source 13 is turned on, by a second adjustment portion 92. In the embodiment, the first adjustment portion 91 and the second adjustment portion 92 modify the electric power which is supplied to the heaters by increasing or decreasing value of current which flows to the heaters. The CPU 81 controls the heat generation amount of the end side heaters H3 and H4 (output ratio in the case that the maximum output is 100%) by controlling the second adjustment portion 92 in accordance with the air flow rate of the exhaust heat fan 42. In this way, the ratios of the heat generation of the end side heaters H3 and H4 with respect to the total heat generation amount of the heaters 363 (the central heaters H1 and H2, and the end side heaters H3 and H4) are controlled. The first adjustment portion 91 and the second adjustment portion 92 configure a supply portion which supplies the electric power to the heaters 363.

Incidentally, the air flow rate of the exhaust heat fan 42 is not limited to being set to 0%, 50%, or 100%. The air flow rate of the exhaust heat fan 42 may be changed stepwise in a greater number of stages, or it may be changed substantially continuously in at least a part of the air flow rate range from 0% to 100%. In those cases as well, it may be controlled stepwise or continuously so that the heat generation amounts (output ratio) of the end side heaters H3 and H4 are increased as the air flow rate of the exhaust heat fan 42 increases. In the embodiment, for simplicity, the air flow rate of the exhaust heat fan 42 is set to any of 0%, 50%, or 100%.

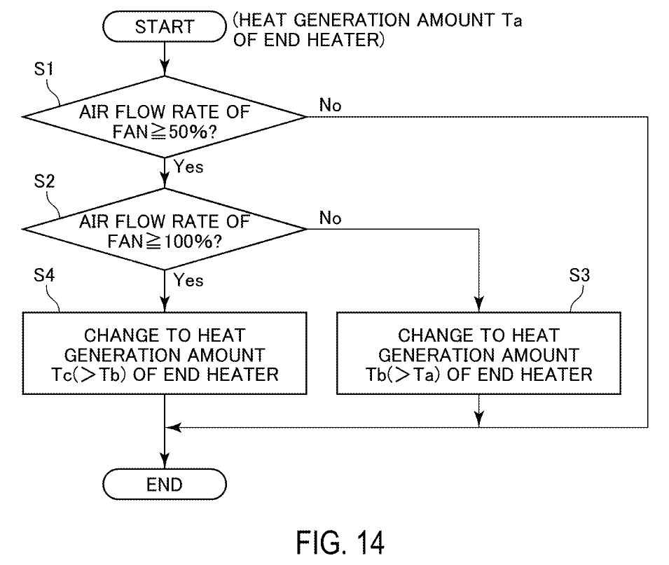

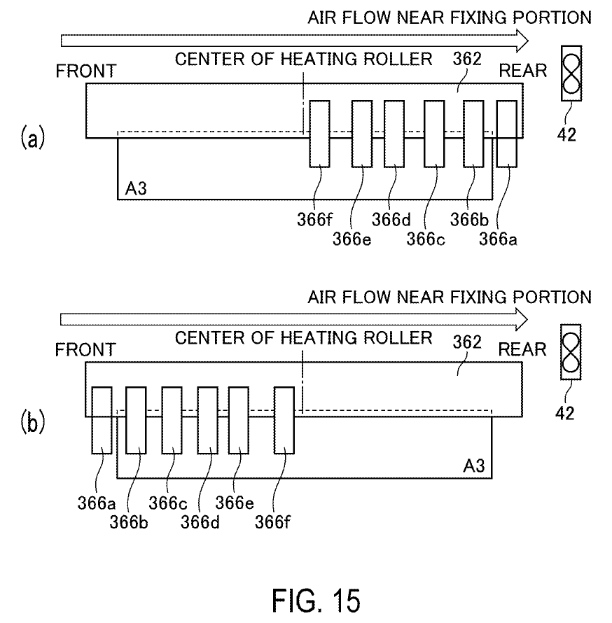

FIG. 14 is a flow chart showing a schematic procedure of controlling the heat generation amount of the heater 363 according to the embodiment. FIG. 14 shows the schematic procedure of controlling the heat generation amount of the heater 363, while the fixing portion 36 is sufficiently heated and the temperature control of the heating roller 362 is performed based on the detected result of temperature by the third fixing temperature sensor 366c (during sheet passing in the job execution). The numbers marked with “S” in FIG. 14 are step numbers for identifying processes. The CPU81 executes the heat generation amount control when, for example, an operation setting of the exhaust heat fan 42 is changed. Further, the heat generation amount of the heater 363 is set to a default setting in a case that the air flow rate of the exhaust heat fan 42 is 0%.

In S1, the CPU 81 checks an operation status (air flow rate) of the exhaust heat fan 42 and determines whether or not the air flow rate is 50% or higher. In a case that the air flow rate of the exhaust heat fan 42 is 50% or higher, the CPU81 proceeds to S2. On the other hand, the CPU 81 terminates the heat generation amount control in a case that the air flow rate of the exhaust heat fan 42 is less than 50%, since the temperature distribution of the heating roller 362 in the longitudinal direction is not affected by the exhaust heat fan 42.

In S2, the CPU 81 checks the operation status (air flow rate) of the exhaust heat fan 42 and determines whether or not the air flow rate is 100% or higher. In a case that the air flow rate of the exhaust heat fan 42 is 100% or higher, the CPU81 proceeds to S4. On the other hand, the CPU81 proceeds to S3 in a case that the air flow rate of the exhaust heat fan 42 is lower than 100%.

In S3, the CPU 81 changes the heat generation amount of the end side heaters H3 and H4 (output ratio in the case that the maximum output is 100%) among the heaters 363 (the central heaters H1 and H2, and the end side heaters H3 and H4). Specifically, since it is a case that the air flow rate of the exhaust heat fan 42 is 50%, the temperature distribution of the heating roller 362 in the longitudinal direction may be as shown in ◆ plot in FIG. 10. Therefore, in this case, the heat generation amount (output ratio) of the end side heaters H3 and H4 is changed to 75%, which is 1.5 times the heat generation amount (output ratio) of the central heaters H1 and H2 which is 50%. As a result, it is possible to show the temperature distribution of the heating roller 362 in the longitudinal direction as ◇ plot in FIG. 12, and it is possible to prevent particularly the temperature on the front side from becoming below the fixing defect occurrence threshold value.

In S4, the CPU 81 changes the heat generation amount of the end side heaters H3 and H4 (output ratio in the case that the maximum output is 100%) among the heaters 363 (the central heaters H1 and H2, and the end side heaters H3 and H4). Specifically, since it is a case that the air flow rate of the exhaust heat fan 42 is 100%, the temperature distribution of the heating roller 362 in the longitudinal direction may be as shown in ▲ plot in FIG. 10. Therefore, in this case, the heat generation amount (output ratio) of the end side heaters H3 and H4 is changed to 100%, which is 2.0 times the heat generation amount (output ratio) of the central heaters H1 and H2 which is 50%. As a result, it is possible to show the temperature distribution of the heating roller 362 in the longitudinal direction as △ plot in FIG. 12, and it is possible to prevent particularly the temperature on the front side from becoming below the fixing defect occurrence threshold value.

Further, as shown in FIG. 12, it is possible to prevent the temperature of the heating roller 362 from rising excessively and exceeding a hot offset occurrence threshold value. That is, based on a relationship as shown in FIG. 12 which is obtained by an experiment, it is possible to determine, in advance, a setting of the heat generation amount of the heater 363 with respect to the air flow rate of the exhaust heat fan 42 as shown in FIG. 11 so that the temperature of heating roller 362 does not become below the fixing defect occurrence threshold value and does not exceed the hot offset threshold value. In this way, it is possible to control the temperature of the heating roller 362 within an appropriate temperature range.

Incidentally, the temperature distribution of the heating roller 362 during sheet passing may be changed depending on a type and a size of the recording material P. Therefore, depending on the type and the size of the recording material P, the setting of the heat generation amount of the heater 363 with respect to the air flow rate of the exhaust heat fan 42 may be changed. That is, in a case that a predetermined recording material P passes through the fixing nip portion N, the ratios of the heat generation of the end side heaters H3 and H4 may be controlled as described above according to the air flow rate of the exhaust heat fan 42. Incidentally, the type of the recording material includes classifications by any information which is possible to distinguish the recording material such as an attribute based on general characteristics which are plain paper, fine paper, coated paper, thick paper, thin paper, etc. (so-called paper type categories), numerical value or numerical value range such as basis weight and thickness, brand name (including manufacturer, product number, etc.). In general, the type of the recording material is often specified by basis weight (or thickness) and paper type category (coated paper, uncoated paper, etc.).

Further, for example, the ratio of the heat generation between the central heaters and the end side heaters among the heaters 363 may be changed at a time when the temperature of the fixing portion 36 is rising and at a time when the job is executing after the temperature of the fixing portion 36 is sufficiently risen. For example, at the time when the temperature of the fixing portion 36 is rising, heat radiation is occurred from an end side, so the temperature of the end side temperatures is not easily to rise. Therefore, at the time when the temperature of the fixing portion 36 is rising, the ratio of the heat generation of the end side heater may be raised. On the other hand, during a time when the temperature of the fixing portion 36 is sufficiently risen and the job is executing, as the recording material P passes through the fixing portion 36, the temperature in the central portion is not easily increased since the recording material P derives the heat, however, the temperature at a position of the end side where the recording material P does not pass through is easily increased. Therefore, during executing the job, the ratio of the heating generation of the central heater may be raised in order to prevent the temperature of the end portion from increasing. Even in the case as well, the heat generation amount of the heater 363, during executing the job at least after the temperature of the fixing portion 36 is sufficiently raised (during sheet passing), may be controlled according to the embodiment.

Further, in the embodiment, the heat generation amount of the central heaters H1 and H2 (output ratio in the case that the maximum output is 100%) is not changed in accordance with the air flow rate of the exhaust heat fan 42, however, it may be changed. However, in this case, the ratios of the heat generation amounts of the end side heaters H3 and H4 are increased as the air flow rate of the exhaust heat fan 42 is increased.

Further, in the embodiment, the heaters which mainly heat the end sides of the heating member in the longitudinal direction are configured to heat both end sides in the longitudinal direction, however, it is not limited to this. The heaters which mainly heat the end sides of the heating member in the longitudinal direction may be divided into a heater which heats one end side and a heater which heats the other end side in the longitudinal direction. Further, the heaters which mainly heat the end sides of the heating member in the longitudinal direction may be configured to heat both end sides or only one end side in the longitudinal direction. Further, the heaters which mainly heat the central portion of the heating member in the longitudinal direction may be configured to heat substantially only the central portion in the longitudinal direction.

In this way, in the embodiment, the image forming apparatus 1 includes, the casing 10, the image forming portion 3 provided inside the casing 10 and configured to form the toner image on the recording material P, the fixing portion 36 provided inside the casing 10 and configured to fix the toner image, formed by the image forming portion 3, onto the recording material P, the fixing portion 36 being provided with the heating member 362 disposed along a longitudinal direction substantially perpendicular to the conveyance direction of the recording material P, the heater 363 configured to heat the heating member 362, and a plurality of sensors 366 is disposed asymmetrically and configured to detect a temperature of the heating member 362, the fan 42 configured to generate the air flow inside the casing 10 from the first end side of the heating member 362 toward the second end side opposite to the first end side in the longitudinal direction, the supplying portions 91 and 92 configured to supply the electric power to the heater 363, and the controller 8 configured to control the supplying portions 91 and 92. And in the embodiment, the heater 363 includes the first heaters (central heaters) H1 and H2 of which a heat generation amount at a position corresponding to a central portion of the heating member 362 in the longitudinal direction is larger than a heat generation amount at a position corresponding to the first end side or which heats at the position corresponding to the central portion and does not heat at the position corresponding to the first end side, and a second heaters (end side heaters) H3 and H4 of which a heat generation amount at the position corresponding to the first end side is larger than a heat generation amount at the position corresponding to the central portion in the longitudinal direction or which heat at the position corresponding to the first end side and do not heat at the position corresponding to the central portion, and wherein the controller 8 controls the supplying portions 91 and 92 to change a ratio of the heat generation amount of the second heaters H3 and H4 with respect to the heat generation amount of the central heaters H1 and H2 and the end side heaters H3 and H4) between a case in which an air flow rate of the fan 42 is a first air flow rate and a case in which the air flow rate of the fan 42 is a second air flow rate different from the first air flow rate. In the embodiment, the controller 8 controls the supplying portions 91 and 92 so that the ratio of the heat generation amount becomes a first ratio in a case in which the air flow rate of the fan 42 is the first air flow rate, and the ratio of the heat generation amount becomes a second ratio lager than the first ratio in a case in which the air flow rate of the fan 42 is the second air flow rate larger than the first air flow rate.

Further, in the embodiment, the second heaters H3 and H4 heat at positions corresponding to the first end side, the central portion and the second end side, respectively, in the longitudinal direction, and the heat generation amount at positions corresponding to the first end side and the second end side, respectively is larger than the heat generation amount at the position corresponding to the central portion. Further, in the embodiment, the plurality of sensors 366 are disposed so as to be positioned on the second end side of an endmost portion of the recording material P on the first end side in the longitudinal direction when a recording material P having a predetermined width in the longitudinal direction passes through the fixing portion 36, and wherein the controller 8 controls the supplying portions 91 and 92 so as to change the ratio of the heat generation amount according to the air flow rate of the fan 42 when the toner image is fixed onto at least the recording material P having the predetermined width. Further, in the embodiment, the plurality of sensors 366 includes a sensor, wherein at least one of the plurality of sensors is asymmetrically and on each of both sides with respect to the center of the heating member 362 in the longitudinal direction. Further, in the embodiment, the controller 8 controls the supplying portions 91 and 92 so as to change the ratio of the heat generation amount by changing an output ratio to a maximum output of the second heaters H3 and H4, of the first heaters H1 and H2 and the second heater H3 and H4.

As described above, according to the embodiment, the ratios of the heat generation of the end side heaters H3 and H4 are controlled based on the influence of the air flow rate of the exhaust heat fan 42 which is determined in advance, in a configuration in which the plurality of fixing temperature sensors 366 are asymmetrically disposed in the longitudinal direction. In this way, even in a case that there is an external factor such as an air flow (wind) which is generated by the exhaust heat fan 42 inside the printer 1, it is possible to appropriately maintain the temperature distribution of the heating roller 362 in the longitudinal direction. That is, this is a heating method of the heater 363 in which the influence of the air flow which is generated by the exhaust heat fan 42 is considered in advance by changing the ratio of the heat generation of the end side heaters H3 and H4 according to the air flow rate of the exhaust heat fan 42. Therefore, even in a configuration in which the plurality of fixing temperature sensors 366 are asymmetrically disposed in the longitudinal direction and it is difficult to accurately detect (or predict) that the temperature distribution of the heating roller 362 in the longitudinal direction is not symmetric, it is possible to appropriately maintain the temperature distribution. In this way, it is possible to prevent the occurrence of the fixing defect due to insufficient temperature and the hot offset due to excessive temperature.

Here, in the configuration in which the temperature distribution of the heating roller 42 in the longitudinal direction becomes asymmetrical due to the influence of the air flow by the exhaust heat fan 369, it is possible to dispose the fixing temperature sensor 366 as follows. That is, as shown in part (a) of FIG. 15, it is possible to configure such that the plurality of fixing temperature sensors 366 are densely disposed on a side closer to the exhaust heat fan 42 with respect to a center of the heating roller 362 in the longitudinal direction. Further, as shown in part (b) of FIG. 15, conversely, it is possible to configure such that the plurality of fixing temperature sensors 366 are densely disposed on a side farther from the exhaust heat fan 42.

However, in the configuration which is shown in part (a) of FIG. 15, it is not possible to detect temperature reduction on the front side, since the fixing temperature sensors 366 are disposed only on the rear side which is less susceptible to the influence of the exhaust heat fan 42. Further, in the configuration which is shown in part (b) of FIG. 15, it is not possible to detect excessive temperature rise on the rear side, since the fixing temperature sensors 366 are disposed only on the front side which is susceptible to the influence of the exhaust heat fan 42.

On the other hand, from perspectives of cost reduction, space saving, etc. it is desirable to asymmetrically dispose the plurality of fixing temperature sensors 366 in the longitudinal direction, as in the embodiment.

According to the heat generation amount control of the embodiment, in the configuration in which the plurality of fixing temperature sensors 366 are asymmetrically disposed in the longitudinal direction like this, it is possible to appropriately maintain the temperature distribution of the heating roller 362 in the longitudinal direction based on the influence of the air flow rate of the exhaust heat fan 42 which is determined in advance.

### Others

As described above, the present invention has been described based on specific embodiments, however, the present invention is not limited to the embodiments which are described above.

In the embodiments which are described above, the embodiments, in which the present invention is applied to a monochrome image forming apparatus, are described, however, the present invention is not limited to this. The present invention may be applied to various types of image forming apparatus, which are, for example, a color image forming apparatus which superposes toner images which are formed on a plurality of photosensitive drums, or a color image forming apparatus which superposes toner images sequentially which are formed on a single photosensitive drum, etc.

Further, in the embodiments which are described above, the electric power which is supplied to the heater is changed by increasing or decreasing the value of the current which flows through the heater, however, the electric power which is supplied to the heater may also be changed by increasing or decreasing an amount of time when a predetermined value of current flows through the heater per unit time.

According to the present invention, in the configuration in which the sensors for detecting the temperature of the fixing portion are asymmetrically disposed in the longitudinal direction, it is possible to appropriately control the temperature of the fixing portion without depending fan operation.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-027419, filed on February 21, 2025, which is hereby incorporated by reference herein in its entirety.

What is claimed is:

1. An image forming apparatus comprising:
a casing:
an image forming portion provided inside the casing and configured to form a toner image on a recording material;
a fixing portion provided inside the casing and configured to fix the toner image, formed by the image forming portion, onto the recording material, the fixing portion being provided with a heating member disposed along a longitudinal direction substantially perpendicular to a conveyance direction of the recording material, a heater configured to heat the heating member, and a sensor configured to detect a temperature of the heating member;
a fan configured to generate an air flow inside the casing from a first end side of the heating member toward a second end side opposite to the first end side in the longitudinal direction;
a supplying portion configured to supply an electric power to the heater; and
a controller configured to control the supplying portion,
wherein to the sensor, no another sensor is disposed at a linearly symmetric position with respect to a center of the heating member in the longitudinal direction,
wherein the heater includes a first heater of which a heat generation amount at a position corresponding to a central portion of the heating member in the longitudinal direction is larger than a heat generation amount at a position corresponding to the first end side or which heats at the position corresponding to the central portion and does not heat at the position corresponding to the first end side, and a second heater of which a heat generation amount at the position corresponding to the first end side is larger than a heat generation amount at the position corresponding to the central portion in the longitudinal direction or which heats at the position corresponding to the first end side and does not heat at the position corresponding to the central portion, and
wherein the controller controls the supplying portion to change a ratio of the heat generation amount of the second heater between a case in which an air flow rate of the fan is a first air flow rate and a case in which the air flow rate of the fan is a second air flow rate different from the first air flow rate.

2. The image forming apparatus according to claim 1, wherein the controller controls the supplying portion so that the ratio of the heat generation amount becomes a first ratio in a case in which the air flow rate of the fan is the first air flow rate, and the ratio of the heat generation amount becomes a second ratio lager than the first ratio in a case in which the air flow rate of the fan is the second air flow rate larger than the first air flow rate.

3. The image forming apparatus according to claim 1, wherein the second heater heats at positions corresponding to the first end side, the central portion and the second end side, respectively, in the longitudinal direction, and the heat generation amount at positions corresponding to the first end side and the second end side, respectively is larger than the heat generation amount at the position corresponding to the central portion.

4. The image forming apparatus according to claim 1, wherein the sensor is disposed so as to be positioned on the second end side of an endmost portion of the recording material on the first end side in the longitudinal direction when a recording material having a predetermined width in the longitudinal direction passes through the fixing portion, and
wherein the controller controls the supplying portion so as to change the ratio of the heat generation amount according to the air flow rate of the fan when the toner image is fixed onto at least the recording material having the predetermined width.

5. The image forming apparatus according to claim 1, further comprising a plurality of sensors including the sensor,
wherein at least one of the plurality of sensors is asymmetrically and on each of both sides with respect to the center of the heating member in the longitudinal direction.

6. The image forming apparatus according to claim 1, wherein the controller controls the supplying portion so as to change the ratio of the heat generation amount by changing an output ratio to a maximum output of the second heater, of the first heater and the second heater.

7. An image forming apparatus comprising:
a casing;
a fixing portion provided inside the casing and configured to fix a toner image, formed by an image forming portion, onto a recording material, the fixing portion being provided with a heating member disposed along a longitudinal direction substantially perpendicular to a conveyance direction of the recording material, a heater configured to heat the heating member, and a sensor configured to detect a temperature of the heating member; and
a fan configured to generate an air flow inside the casing from a first end side of the heating member toward a second end side opposite to the first end side in the longitudinal direction,
wherein the sensor is disposed so as to be positioned on the second end side of an endmost portion of the recording material on the first end side in the longitudinal direction when a recording material having a predetermined width in the longitudinal direction passes through the fixing portion.
